(19) United States
(12) Patent Application Publication
(10) Pub. No.: US 2015/0076991 A1
(43) Pub. Date: Mar. 19, 2015

(54) Lighting Control System, Lighting Control Method and Storage Medium

(71) Applicant: Toshiba Lighting & Technology Corporation, Yokosuka-shi (JP)

(72) Inventors: Hisashi Yamamoto, Yokosuka-shi (JP); Hidenori Nishigaki, Yokosuka-shi (JP); Sayaka Kikuta, Yokosuka-shi (JP); Junko Takahashi, Yokosuka-shi (JP)

(73) Assignee: TOSHIBA LIGHTING & TECHNOLOGY CORPORATION, Yokosuka-shi (JP)

(21) Appl. No.: 14/200,273

(22) Filed: Mar. 7, 2014

(30) Foreign Application Priority Data
Sep. 19, 2013 (JP) 2013-194465

(51) Int. Cl. H05B 37/02

(52) U.S. Cl. CPC H05B 37/02
USPC 315/153

(57) ABSTRACT

According to an embodiment, a lighting control system includes a smartphone and a lighting control device, and the smartphone includes an illuminance sensor and a wireless communication section. The lighting control device performs dimming control of a plurality of lighting apparatuses that respectively illuminate the plurality of areas, based on detected values of a plurality of areal illuminance sensors, which detect brightness of the plurality of areas, and performs calibration of the areal illuminance sensors, based on a detected value of the illuminance sensor of the smartphone, which is received in a wireless communication device.

### CROSS-REFERENCE TO RELATED APPLICATIONS

This application is based upon and claims the benefit of priority from the prior Japanese Patent Application No. 2013-194465 filed in Japan on Sep. 19, 2013; the entire contents of which are incorporated herein by reference.

### FIELD

Embodiments described herein relate generally to a lighting control system, a lighting control method and a storage medium.

### BACKGROUND

In the related art, a lighting control system for controlling lighting is widely used in an office or the like. A plurality of lighting apparatuses are disposed in a plurality of areas and one or two or more lighting apparatuses are disposed corresponding to each area. A lighting control device controls each lighting apparatus in response to illuminance of each area for lighting each area with a predetermined illuminance.

In this case, the lighting control device obtains information of an illuminance value indicating brightness from an illuminance sensor that is a brightness sensor that detects the brightness of each area. The illuminance sensor is disposed in a ceiling or the like of each area and detects the brightness of a floor surface of the area by detecting reflected light of illumination light.

Calibration of the illuminance sensor is necessarily performed at least one time after installation and is performed with respect to all of a plurality of illuminance sensors disposed in the office or the like.

However, when calibrating, a person performing the calibration performs work in which illuminance is measured by installing an illuminometer in a predetermined position, for example, on a desk of each area, a measured value of the illuminance is input into a personal computer, and input data as calibration data is transmitted from the personal computer to the lighting control device.

The lighting control device performs the calibration of an output value of the areal illuminance sensor, based on an illuminance value of each area which is received. Then, the person performing the calibration must perform the calibration operation with respect to all of the plurality of illuminance sensors disposed in the office or the like and there is a problem that the calibration work is complex and takes time.

### BRIEF DESCRIPTION OF THE DRAWINGS

FIG. 1 is a configuration view of a lighting control system according to a first embodiment.

FIG. 2 is a plan view of an office illustrating an installation example of illuminance sensors according to the first embodiment.

FIG. 3 is a view illustrating positions of lighting apparatuses and the illuminance sensor in the office according to the first embodiment.

FIG. 4 is a perspective view illustrating a configuration of a smartphone as a portable terminal according to the first embodiment.

FIG. 5 is a flowchart illustrating an example of a flow of calibration in a smartphone according to the first embodiment.

FIG. 6 is a flowchart illustrating an example of a flow of calibration in a lighting control device according to the first embodiment.

FIG. 7 is a diagram illustrating an example of an operation screen that is displayed on a screen of a display section of the smartphone according to the first embodiment.

FIG. 8 is a view illustrating a state where a selected area is displayed identifiably from other areas according to the first embodiment.

FIG. 9 is a view illustrating a display state of an operation screen if a second illuminance is transmitted according to the first embodiment.

FIG. 10 is a view illustrating an example of a screen of the operation screen if a calibration operation is finished with respect to one area according to the first embodiment.

FIG. 11 is a flowchart illustrating an example of a flow of calibration in a smartphone according to a second embodiment.

FIG. 12 is a flowchart illustrating an example of a flow of calibration in a lighting control device according to the second embodiment.

FIG. 13 is a view illustrating an example of an operation screen displaying illuminance on a screen of a display section of the smartphone according to the second embodiment.

FIG. 14 is a view illustrating a display example of the operation screen after the smartphone transmits an illuminance value twice according to the second embodiment.

### DETAILED DESCRIPTION

A lighting control system of an embodiment has a portable terminal device and a lighting control device. The portable terminal device has an illuminance sensor and a wireless communication section. The lighting control device performs dimming control of a plurality of lighting apparatuses that illuminate a plurality of areas, respectively, based on a detected value of a plurality of areal illuminance sensors, which detect brightness of the plurality of areas, and performs calibration of the areal illuminance sensors, based on a detected value of the illuminance sensor of the portable terminal device, which is transmitted from the wireless communication section.

### First Embodiment

### Configuration

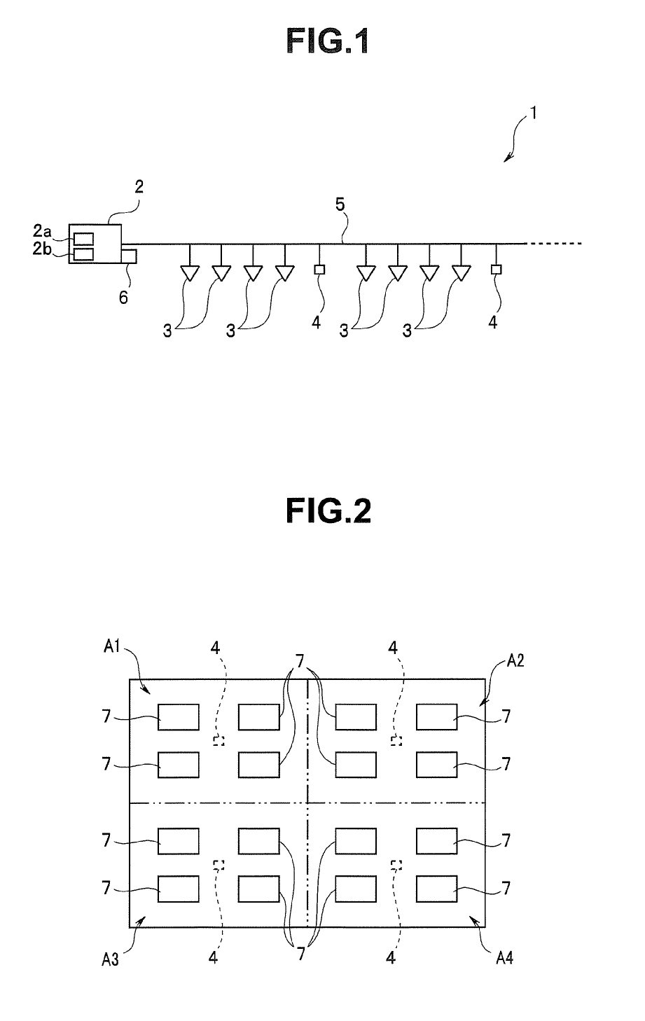

FIG. 1 is a configuration view of a lighting control system 1 according to the embodiment. The lighting control system 1 is configured by including a lighting control device 2, a plurality of lighting apparatuses 3 and a plurality of illuminance sensors 4. The lighting control device 2 is connected to the plurality of lighting apparatuses 3 and the plurality of illuminance sensors 4 by a communication line 5.

The lighting control device 2 is connected to a wireless communication device 6. The wireless communication device 6 is a wireless communication section of access points of a wireless LAN such as WiFi. The lighting control device 2 can communicate with a portable terminal such as a smartphone through the wireless communication device 6.

Here, the lighting control device 2 is a device that controls illumination of a plurality of areas (here, areas of A1 to A4) of a certain office, and the wireless communication device 6 is capable of receiving a signal from the portable terminal corresponding to WiFi or the like inside the plurality of areas thereof.

Moreover, here, the wireless communication device 6 is connected to the lighting control device 2, but the wireless communication device 6 may be built in the lighting control device 2.

The lighting control device 2 has a central processing unit (hereinafter, referred to as a CPU) 2a and a storage device 2b. The storage device 2b includes a ROM, a RAM, a hard disk drive or the like, and stores various types of programs such as a lighting control program and a calibration processing application (a control section calibration processing application program described below) for calibration of an illuminance value that is detected in each illuminance sensor 4 described below, and various types of data. As one of various types of data, data of a layout view of the office including the areas A1 to A4 is stored in the storage device 2b in advance.

The lighting control program is a program for performing the dimming control of the plurality of lighting apparatuses 3 that illuminate the plurality of areas, based on a detected value of the illuminance sensor 4 detecting the illuminance that is the brightness of each area. The calibration processing application program is a program performing the calibration of the illuminance sensor 4 provided in each area.

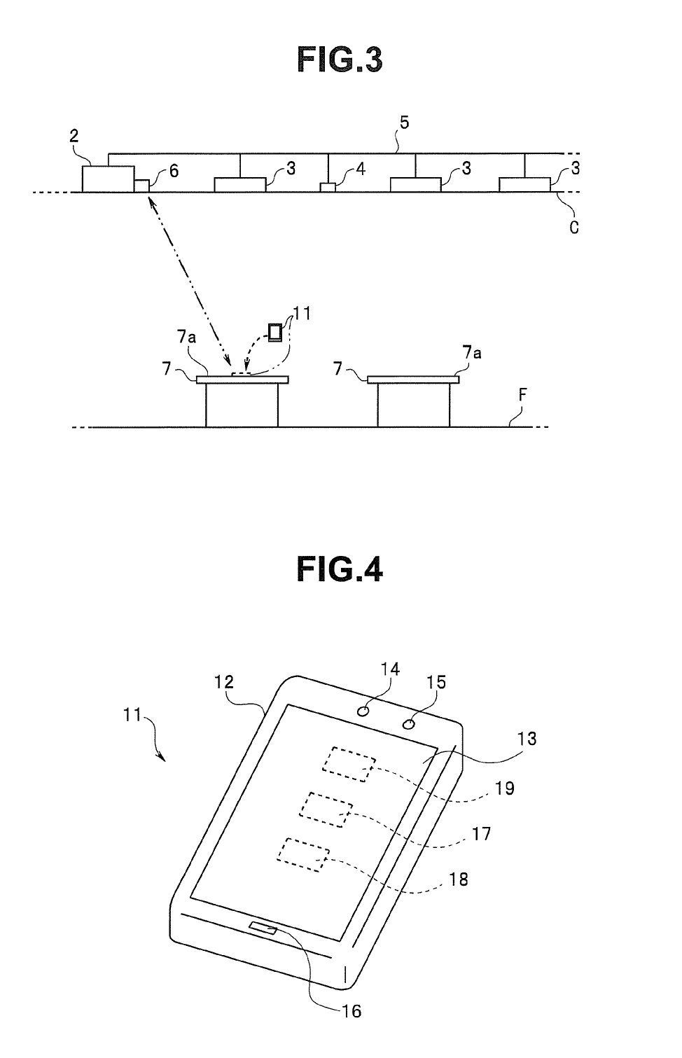

FIG. 2 is a plan view of the office illustrating an arrangement example of the illuminance sensors 4. FIG. 3 is a view illustrating positions of the lighting apparatuses 3 and the illuminance sensor 4 in the office. For the sake of simplifying the description, in FIG. 2, a certain office is divided in four areas A1 to A4, four desks 7 are disposed on a floor F in each area and the illuminance sensor 4 (illustrated in a dotted line) is disposed on a ceiling C of a center portion of each area. Each illuminance sensor 4 measures the illuminance of a corresponding area.

If the illumination is turned on and off by a wall switch (not illustrated) and the like, the lighting control device 2 controls each lighting apparatus 3, based on the detected value of the illuminance sensor 4 so that each area is a predetermined brightness that is set. The control is performed by reading and executing the lighting control program from the storage device 2b in the CPU 2a.

FIG. 4 is a perspective view illustrating a configuration of the smartphone as the portable terminal.

The smartphone 11 has a display section 13 provided on a surface of a device body 12 and has a speaker 14, an illuminance sensor 15, a microphone 16 or the like around the display section 13. Since the display section 13 is a display device with a touch panel, a user is capable of designating or selecting a command or the like by touching the screen of the display section 13 with a finger or the like.

A central processing unit (hereinafter, referred to as CPU) 17, a flash memory 18 as a rewritable nonvolatile memory, a wireless communication section 19 for communicating with the WiFi or the like, a ROM and a RAM (not illustrated) are built in a body of the smartphone 11. The CPU 17 can execute applications stored in the flash memory 18 and the ROM by using the RAM that is a memory for working.

The illuminance sensor 15 is a detector for detecting the illuminance, based on an amount of incident light. The illuminance sensor 15 is calibrated in advance by an illuminance sensor (not illustrated) for the calibration. As described below, the smartphone 11 may display the illuminance value on the display section 13 or may transmit information of the illuminance value which is displayed to the lighting control device 2 through the wireless communication section 19, based on an output signal of the illuminance sensor 15 thereof.

Moreover, before the calibration of the illuminance sensor 4 of the lighting control system 1 is performed by using the smartphone 11, the calibration of the illuminance sensor 15 of the smartphone 11 is performed, if necessary. For example, the calibration of the illuminance of the illuminance sensor 15 of the smartphone 11 is performed by radiating light, which is the same as the light measured in an illuminometer to be a reference for the calibration, on the illuminance sensor 15 of the smartphone 11 and by matching an output (for example, an output voltage) at that time to the illuminance value of the illuminometer to be the reference.

Further, the smartphone 11 is capable of communicating with the lighting control device 2 through the wireless communication device 6 that is the access point. Therefore, the smartphone 11 is a portable terminal device having the illuminance sensor 15 and the wireless communication section 19.

As described above, since the smartphone 11 can start and execute various types of application programs (hereinafter, also referred to as application) by the CPU 17, the user can execute a desired application by downloading and storing the desired application in the flash memory 18 of the smartphone 11 by using the wireless communication device 6 or Internet.

Here, the calibration of illuminance sensor 4 in the lighting control system 1 is described in which the user downloads the application for performing the calibration of illuminance sensor 4 described below in the smartphone 11 in advance from the wireless communication device 6 or through the Internet.

That is, the smartphone 11 performs the calibration of the illuminance sensor 4 provided in each area, that is, the calibration of the areal illuminance sensor by executing the application program that is downloaded through the wireless communication section 19.

Then, the lighting control device 2 performs the dimming control of the plurality of lighting apparatuses 3 that illuminate the plurality of areas, based on the detected values of the illuminance sensors 4 that are the plurality of areal illuminance sensors, which detect the brightness of the plurality of areas, and performs the calibration of the illuminance sensor 4 that is the areal illuminance sensor, based on the detected value of the illuminance sensor 15 of the smartphone 11, which is transmitted from the smartphone 11 and received in the wireless communication device 6.

### Operation

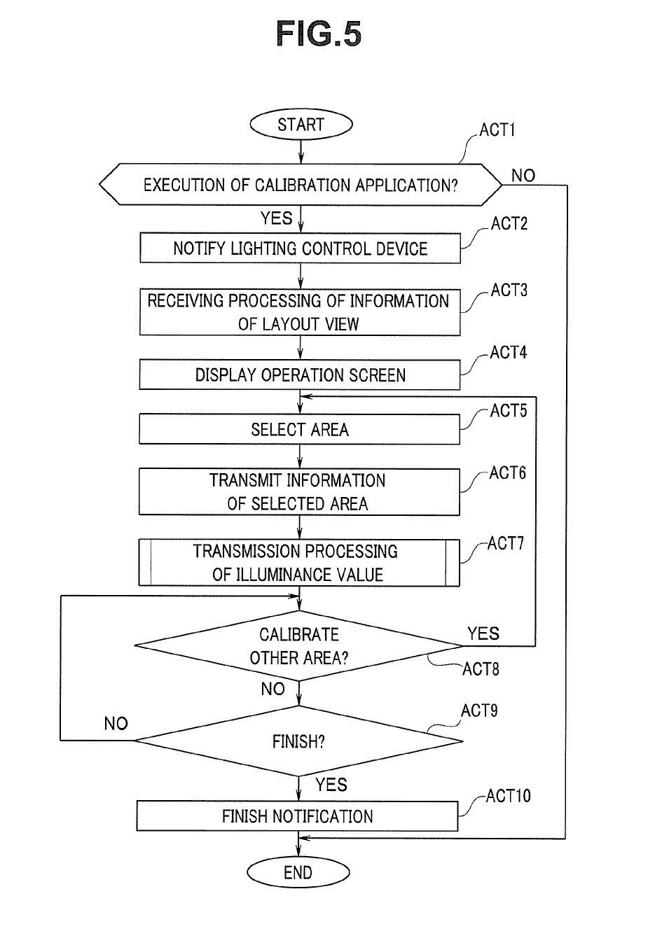

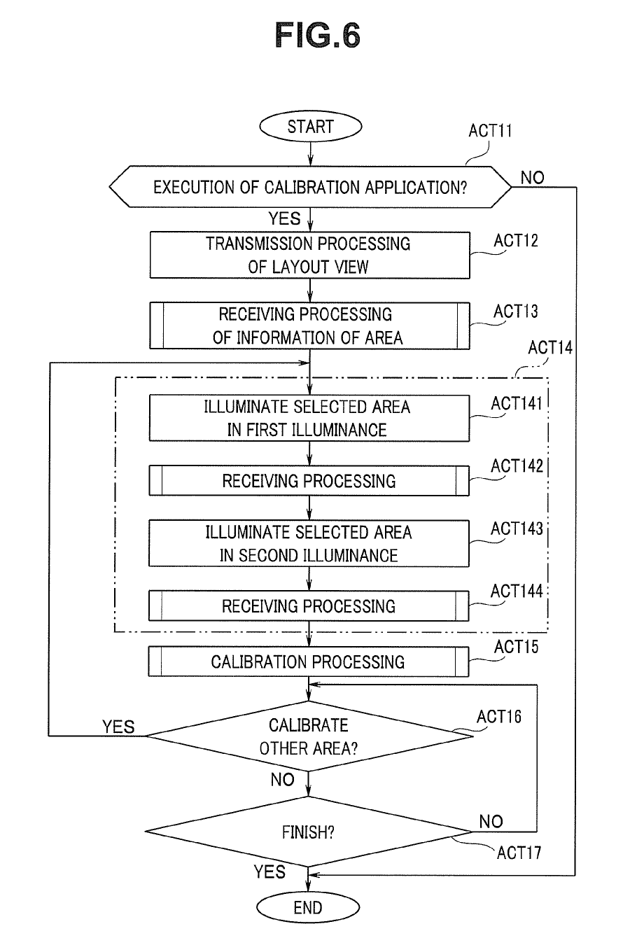

FIG. 5 is a flowchart illustrating an example of a flow of the calibration in the smartphone 11. FIG. 6 is a flowchart illustrating an example of a flow of the calibration in the lighting control device 2.

The processing of FIG. 5 is a processing of an illuminance sensor calibration application (hereinafter, referred to as a terminal calibration application) AP1 of the smartphone 11 and is executed by the CPU 17. The processing of FIG. 6 is a processing of an illuminance sensor calibration processing application program (hereinafter, referred to as a control section calibration application) AP2 of the lighting control device 2 and is executed by the CPU 2a.

The smartphone 11 determines whether or not the execution of the terminal calibration application AP1 is instructed (Act 1). The determination in Act 1 is performed by the user of the smartphone 11 who performs the calibration of the illuminance sensor 4, based on the operation of the smartphone 11.

If the execution of the terminal calibration application AP1 is not instructed (Act 1: NO), no processing is performed.

If the execution of the terminal calibration application AP1 is instructed (Act 1:YES), the smartphone 11 notifies that the execution of the calibrating is instructed to the lighting control device 2 (Act 2).

As illustrated in FIG. 6, the lighting control device 2 determines whether or not the execution of the terminal calibration application AP1 is started in the smartphone 11 through the wireless communication device 6 (Act 11). The determination in Act 11 is performed, based on presence or absence of receiving of the notice of Act 2.

When receiving the notice of Act 11 (Act 11:YES), the lighting control device 2 executes transmitting of a layout view of the plurality of areas A1 to A4 in which lighting control is performed (Act 12). Since data of the layout view is stored in the storage device 2b in advance, the lighting control device 2 reads the information of the layout view from the storage device 2b and transmits the information to the smartphone 11 through the wireless communication device 6.

In the smartphone 11, receiving of the information of the layout view is executed (Act 3) and the operation screen including the received layout view is displayed on the screen 13a of the display section 13 (Act 4).

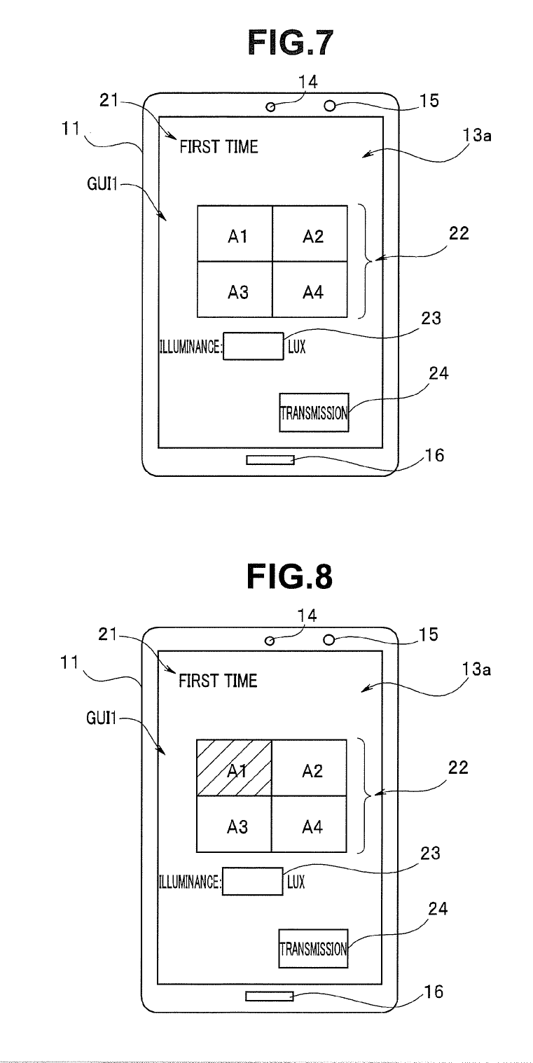

FIG. 7 is a view illustrating an example of the operation screen displayed on the screen 13a of the display section 13 of the smartphone 11. FIG. 7 illustrates a state where the layout view is displayed in the display section 13 by receiving the layout view of the office from the lighting control device 2 by the smartphone 11.

The terminal calibration application AP1 displays the operation screen GUI1 thereof on the screen 13a of the display section 13 by generating the operation screen GUI1 for the calibration.

The operation screen GUI1 for the calibration includes a count display section 21 that displays the number of times of illuminance measurement when calibrating, a layout display section 22 that displays the layout view of the areas A1 to A4, an illuminance display section 23 that displays the illuminance value that is measured by the illuminance sensor 15, and a transmitting button 24. In FIG. 7, since it is the first detection of the illuminance, characters of “first time” are generated and displayed on the count display section 21.

Further, an image of the layout view received from the lighting control device 2 is displayed on the layout display section 22. Moreover, the terminal calibration application AP1 generates and displays the layout view on the layout display section 22 so that the user can designate each area of the layout view displayed on the layout display section 22 by touching the touch panel of the display section 13.

The illuminance value measured in the illuminance sensor 15 is displayed in a unit of lux on the illuminance display section 23. Here, if the illuminance is measured, the terminal calibration application AP1 displays the measured illuminance value on the illuminance display section 23.

The transmitting button 24 is an operation button for instructing the transmission of measured illuminance value data to the lighting control device 2 by touching of the user. The transmitting button 24 is generated and displayed by the terminal calibration application AP1.

If the user selects an area on the operation screen GUI′ for the calibration, that is, if an area in which the calibration is performed is touched in the layout view displayed on the layout display section 22, area selecting is executed (Act 5). In Act 5, if the selection of the area is confirmed, the CPU 17 executes displaying of the selected area identifiably from other areas.

That is, in the smartphone 11 that is the portable terminal device, the area in which the calibration is performed is selected and the information of the selected area is transmitted to the lighting control device 2 by the wireless communication section 19. Therefore, the smartphone 11 has the display section 13 displaying the layout display section 22 that displays the layout view for selecting the area in which the calibration is performed in the displayed plurality of areas by displaying the plurality of areas. Thus, the smartphone 11 displays the layout view on the display section 13 by receiving the information of the layout view of the plurality of areas from the lighting control device 2 or through the Internet to select the area in which the calibration is performed.

FIG. 8 is a view illustrating a state where the selected area is displayed identifiably from the other areas. In FIG. 8, the area A1 is selected and the area A1 is displayed with brightness or a color (hatched) different from other areas A2 to A4.

The smartphone 11 transmits the information of the selected area to the lighting control device 2 (Act 6). For example, if the user selects the area A1, since the information indicating that the area A1 is selected is transmitted to the lighting control device 2, the lighting control device 2 executes the receiving of the information of the area (Act 13).

After Act 13, the lighting control device 2 executes the illuminance value receiving for the calibration (Act 14).

In Act 14, first, one or two or more lighting apparatuses 3 which illuminate the area A1 are controlled so that the area A1 that is selected is illuminated in a predetermined first illuminance (Act 141), based on the information of the area received in Act 13.

On the other hand, in the smartphone 11, if the illumination of the area A1 is changed, the illuminance value after the illumination is changed is displayed on the illuminance display section 23 of the operation screen GUI1. The user performs the transmission of the illuminance value of the first time by touching the transmitting button 24 while confirming the illuminance value displayed on the illuminance display section 23.

In the lighting control device 2, if the illuminance value is received from the smartphone 11 (Act 142), one or two or more lighting apparatuses 3 that illuminate the area A1 are controlled so that the selected area A1 is illuminated in a predetermined second illuminance (Act 143). A control signal is supplied to each lighting apparatus 3 so that the second illuminance by one or two or more lighting apparatuses 3 that illuminate the area A1 is illuminated differently from the first illuminance.

If the illumination of a second time is changed in the area A1, the illuminance value after the illumination is changed is displayed on the illuminance display section 23 of the operation screen GUI1. The user performs the transmission of the illuminance value of the second time by touching the transmitting button 24 while confirming the illuminance value displayed on the illuminance display section 23.

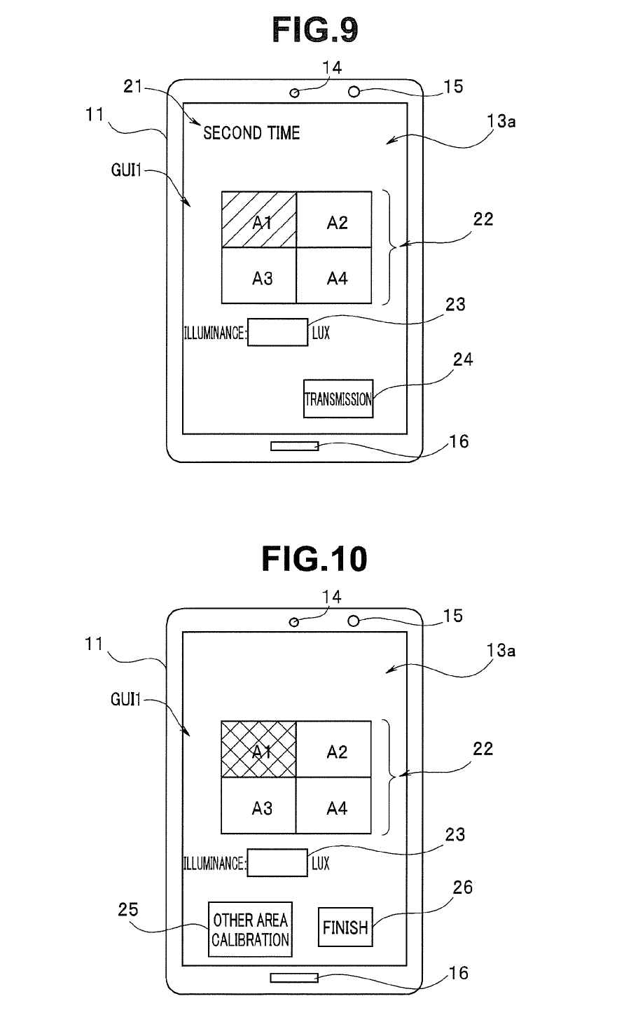

FIG. 9 is a view illustrating a display state of the operation screen GUI1 if the illuminance of the second time is transmitted. As illustrated in FIG. 9, since the display state is after the illuminance of the first time is transmitted, the terminal calibration application AP1 generates and displays characters of “second time” on the count display section 21.

The transmitting of the illuminance value of the second time described above is performed in Act 7.

If the illuminance value is received twice from the smartphone 11, the lighting control device 2 performs the calibrating that calibrates the illuminance sensor 4 of the area A1, based on the two illuminance values (Act 15).

In the calibrating in Act 15, the lighting control device 2 newly produces a proportional relationship expression between an output value of the illuminance sensor 4 and the illuminance value, based on a proportional relationship between two output values of the illuminance sensor 4 of the area A1 and two illuminance values which are received when performing the illumination of the first time and the second time.

For example, if the illuminance value received in the first time is 500 lux and the illuminance value received in the second time is 250 lux, the lighting control device 2 obtains the proportional relationship expression from a output value V1 of the illuminance sensor 4 when the illuminance value is 500 lux and an output value V2 of the illuminance sensor 4 when the illuminance value is 250 lux. Then, the lighting control device 2 can obtain the illuminance from the output value (for example, a voltage value) of the illuminance sensor 4, based on the proportional relationship expression thereof. That is, the smartphone 11 transmits two detected values which are different from each other in the selected area and the lighting control device 2 performs the calibration of the illuminance sensor 4 of the area, based on the two detected values which are received.

In the smartphone 11, if the transmission of the illuminance value of the second time is finished, the operation screen GUI1 is as illustrated in FIG. 10. FIG. 10 is a view illustrating an example of the screen of the operation screen GUI1 when a calibration operation is finished with respect to one area.

As illustrated in FIG. 10, if the calibration of one area is finished, in order to instruct to perform the calibration of the other areas, another area calibration button 25 and a finish button 26 are displayed. Therefore, the user can touch the other area calibration button 25 when continuously performing the calibration of the other areas and can touch the finish button 26 when finishing the calibration.

If the other area calibration button 25 is touched, the operation screen GUI1 of the smartphone 11 is as illustrated in FIG. 10 and the user can perform the selection of the area.

In FIG. 10, the area in which the calibration is performed already is displayed in predetermined brightness or color (netted) and the area in which the calibration is finished is displayed so that the user can confirm the area. On the other hand, the area in which the calibration has been performed already may be displayed by characters that indicate the finish of the calibration.

If the user touches the other area calibration button 25 (Act 8:YES), the processing proceeds to Act 5. If the user does not touch the other area calibration button 25 (Act 8:NO), the smartphone 11 determines whether or not the finish is instructed, that is, the finish button 26 is touched (Act 9).

If the finish button 26 is not touched (Act 9:NO), the processing proceeds to Act 8. If the finish button 26 is touched (Act 9:YES), finish noticing is executed (Act 10). In the finish noticing, the smartphone 11 finishes the processing of the terminal calibration application AP1 by transmitting a message that notifies of the finish of calibrating to the lighting control device 2.

If the user touches the other area calibration button 25 (Act 8:YES) and selects another area in which the next calibration is performed (Act 5), the information of the selected other area is transmitted (Act 6). Therefore, the lighting control device 2 determines (Act 16) presence or absence of the instruction of the calibration of the other area after the calibration is processed (Act 15). If the lighting control device 2 receives the information of the selected other area (Act 16:YES), the processing proceeds to Act 14 in the lighting control device 2. As a result, the calibration of the other area is performed as described above.

In the lighting control device 2, if the user does not touch the other area calibration button 25 (Act 16:NO) and does not touch the finish button 26 (Act 17:NO) either, the processing returns to Act 16. If the finish button 26 is touched, the finish notice is received, so the lighting control device 2 finishes the processing of the control section calibration application AP2.

As described above, according to the lighting control system of the above embodiment, it is possible to simply perform the calibration on the plurality of illuminance sensors in the plurality of areas by using the portable terminal.

### Second Embodiment

In the first embodiment, the area in which the calibration of the illuminance sensor 4 is performed is selected in the portable terminal by the user, but in the second embodiment, the area in which the calibration of the illuminance sensor 4 is performed is selected and designated in the lighting control device 2.

Since a configuration of the lighting control system of the embodiment is the same as that of the lighting control system 1 of the first embodiment illustrated in FIG. 1, the description thereof is omitted. Hereinafter, the embodiment is described with respect to points different from the first embodiment.

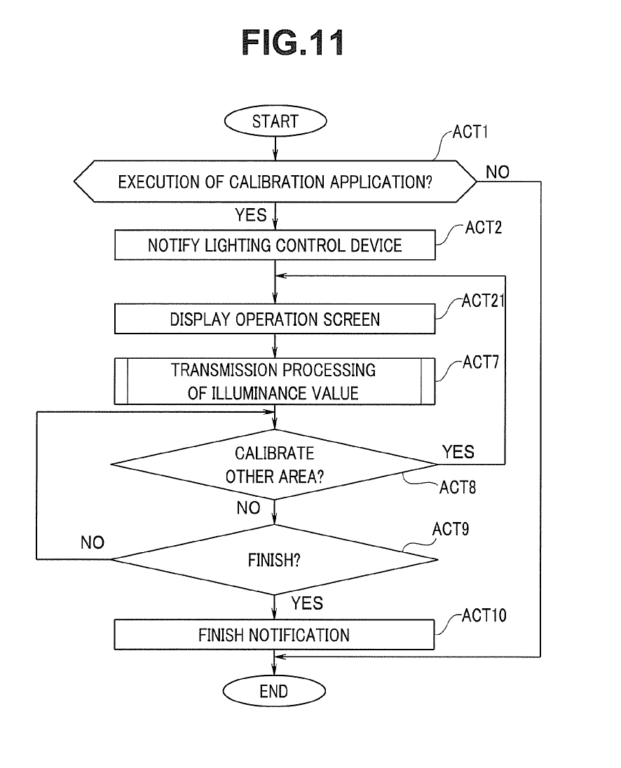

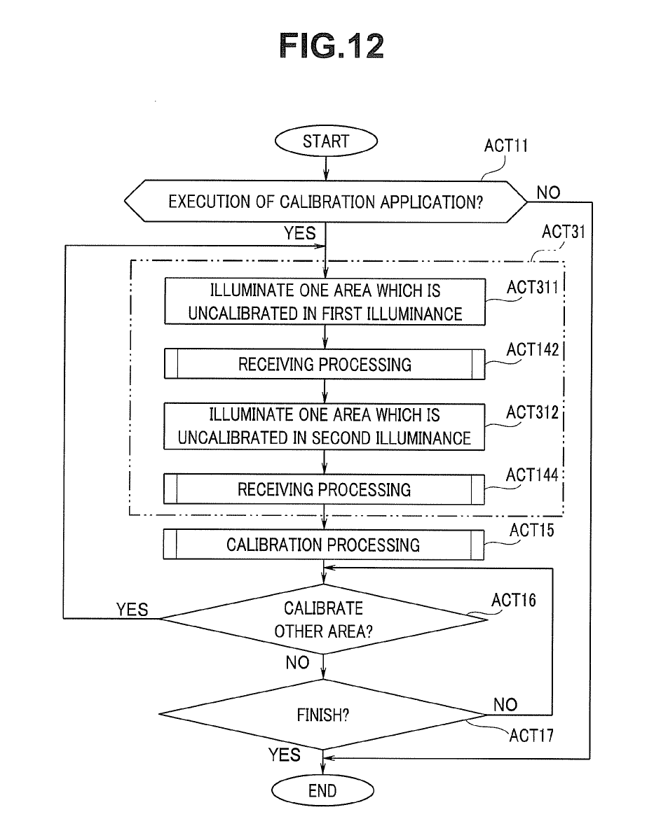

FIG. 11 is a flowchart illustrating an example of a flow of the calibration in the smartphone 11. FIG. 12 is a flowchart illustrating an example of a flow of the calibration in the lighting control device 2. In FIGS. 11 and 12, the same Act numerals are given to the same processing acts as the processing acts of FIGS. 5 and 6, and the description thereof is simplified, and different points thereof are described in detail.

The processing of FIG. 11 is also the processing of a terminal calibration application AP3 of the smartphone 11 and is performed by the CPU 17. The terminal calibration application AP3 can also be executed by downloading a desired application from the wireless communication device 6 or through the Internet to the flash memory 18 of the smartphone 11 by the user. Further, the terminal calibration application AP3 may be a program installed in advance in the smartphone 11.

The processing of FIG. 12 is a processing of a control section calibration application AP4 of the lighting control device 2 and is executed by the CPU 2a.

The smartphone 11 determines whether or not the performance of the terminal calibration application AP3 is instructed (Act 1) and if the performance of the terminal calibration application AP3 is instructed (Act 1:YES), the smartphone 11 notifies that the performance of the calibrating is instructed to the lighting control device 2 (Act 2).

As illustrated in FIG. 12, the lighting control device 2 determines whether or not the execution of the terminal calibration application AP3 is started in the smartphone 11 through the wireless communication device 6 (Act 11). If it is determined that the performance of the terminal calibration application AP3 is started, based on receiving of the notice of the execution from the smartphone 11 (Act 11:YES), the lighting control device 2 executes the illuminance value receiving for the calibration (Act 31).

The lighting control device 2 can receive a signal inside the areas A1 to A4 from the smartphone 11 through the wireless communication device 6.

In Act 31, the lighting control device 2 determines and extracts uncalibrated areas in the plurality of areas A1 to A4, and selects one of a plurality of uncalibrated areas which are extracted. Then, the lighting control device 2 controls one or two or more lighting apparatuses 3 that illuminate the uncalibrated areas which are selected so as to be illuminated in a predetermined first illuminance (Act 311).

The lighting control device 2 has information for managing whether or not the calibration of the illuminance sensor 4 is performed for each area and, for example, selects one area A1 from all areas if all areas are not calibrated, and controls the lighting apparatus 3 of the selected area A1 so that the selected area A1 has the predetermined first illuminance. For example, the plurality of lighting apparatuses 3 are dimmed so that the selected area is predetermined brightness which is darker than that of areas surrounding the selected area, for example, the brightness is 75% of that of the surrounding areas.

Since the brightness of the selected area A1 is changed and then the brightness of the area A1 is different from the brightness of the other areas A2, A3 and A4, the user can recognize that the area in which the illuminance is measured is the area A1. Therefore, the user disposes the smartphone 11 in a position for treatment of the area A1. In the smartphone 11 disposed in the area A1, the illuminance is measured by the illuminance sensor 15 and the illuminance value thereof is displayed on the illuminance display section 23 of the operation screen GUI1.

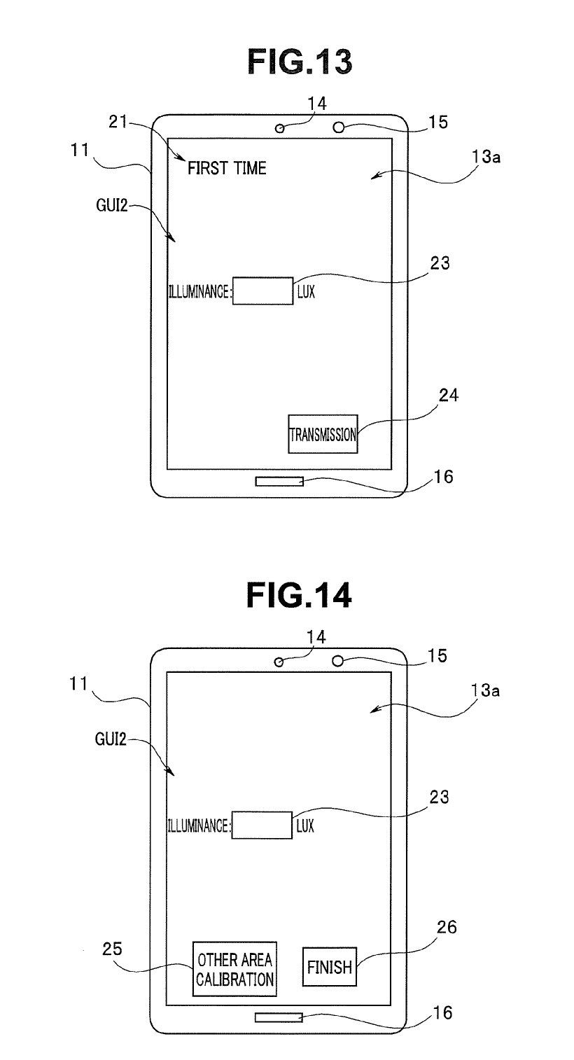

FIG. 13 is a view illustrating an example of an operation screen that displays the illuminance on the screen 13a of the display section 13 of the smartphone 11. In the operation screen GUI2 of FIG. 13, the layout view of the office as illustrated in FIGS. 7 to 11 is not displayed.

The user performs the transmission of the illuminance value of the first time by touching the transmitting button 24 while confirming the illuminance value displayed on the illuminance display section 23.

If the illuminance value is received from the smartphone 11 (Act 142), the lighting control device 2 controls one or two or more lighting apparatuses 3 that illuminate the area A1 so that the area A1 is illuminated in a predetermined second illuminance (Act 312). At this time, the control signal is also supplied to each lighting apparatus 3 so that the second illuminance that is controlled by one or two or more lighting apparatuses 3 that illuminate the area A1 is different from the first illuminance. For example, the plurality of lighting apparatuses 3 are dimmed so that the selected area has a predetermined brightness which is darker than that of areas surrounding the selected area, for example, the brightness is 50% of that of the surrounding areas.

If the illumination of a second time is changed in the area A1, the illuminance value at the time when the illumination is changed is displayed on the illuminance display section 23 of the operation screen GUI2. The user performs the transmission of the illuminance value of the second time by touching the transmitting button 24 while confirming the illuminance value displayed on the illuminance display section 23.

The transmitting of the illuminance value of the second time described above is performed in Act 7. If two detected values, that is, the illuminance values are received, the lighting control device 2 performs the calibration of the illuminance sensor 4 of the selected area, based on the two detected values (Act 15).

That is, the lighting control device 2 performs the calibration of the illuminance sensor 4 of the selected area by selecting the area in which the calibration is performed and by using the detected value of the illuminance sensor 15, which is received with respect to the selected area. Then, the lighting control device 2 performs the dimming control of the plurality of lighting apparatuses 3 so that the brightness of the selected area is different from that of areas other than the selected area. Therefore, the selected area is shown to a person who performs the calibration.

FIG. 14 is a view illustrating an example of display of the operation screen GUI2 after the smartphone 11 transmits the illuminance value twice. As illustrated in FIG. 14, in the smartphone 11, after processing of Act 7, the other area calibration button 25 and the finish button 26 are displayed on the operation screen GUI2 to instruct that the calibration of the other area is performed. Therefore, the user can touch the other area calibration button 25 when continuously performing the calibration of the other areas and can touch the finish button 26 when finishing the calibration.

If the other area calibration button 25 is touched, the smartphone 11 displays the operation screen by transmitting the calibration signal of the other area to the lighting control device 2 (Act 21). If the lighting control device 2 receives the calibration instruction of the other area (Act 16:YES), the processing returns to Act 31 and selects the uncalibrated area and controls the lighting apparatuses 3 of the area so that the area is the predetermined first illuminance (Act 311). The processing thereafter is as described above.

The processing in the smartphone 11 and the lighting control device 2 thereafter is similar to that described in the first embodiment.

As described above, according to the lighting control system of the above embodiment, it is possible to simply perform the calibration of the plurality of illuminance sensors of the plurality of areas by using the portable terminal.

In the two embodiments described above, as the portable terminal, the smartphone that is a multi-function mobile phone is used, but the portable terminal is not limited to the smartphone and may be a personal digital assistant (PDA), a tablet terminal or the like.

Furthermore, in the lighting control system of the two embodiments described above, selection of the area is performed in the smartphone 11 by the user, but the selection may be automatically performed in the lighting control device. Otherwise, if a short-range communication function is provided in a lighting apparatus and the smartphone 11 is brought close to the lighting apparatus, the lighting control device 2 may change the illuminance of the selected area by selecting the area to which the lighting apparatus to which the smartphone 11 is brought close belongs.

Further, in the two embodiments described above, the smartphone 11 that is the portable terminal transmits the illuminance value to the lighting control device 2, but may transmit an output value, for example, a voltage value of the illuminance sensor 15 to the lighting control device 2 instead of the illuminance value. In this case, the lighting control device 2 has corresponding information such as a corresponding table between the output value and the illuminance value, and converts the output value of the illuminance sensor 15 which is received into the illuminance value.

Furthermore, in the two embodiments described above, the terminal calibration application of the smartphone is the application program which is downloaded, but may be a program installed in the portable terminal such as the smartphone.

Further, all or a part of the program performing the operation described above is recorded or stored in a portable medium such as a flexible disk, a CD-ROM or a storage medium such as a hard disk as a computer program product. The program is read by the computer and all or a part of the operation is executed. Otherwise, all or a part of the program can be distributed or provided through a communication network. The user can easily realize the lighting control system of the embodiment by installing the program in the computer by downloading the program through the communication network or by installing the program in the computer from the recording medium.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A lighting control system comprising:
a portable terminal device that includes an illuminance sensor and a wireless communication section; and
a lighting control device that performs dimming control of a plurality of lighting apparatuses that respectively illuminate a plurality of areas, based on detected values of a plurality of areal illuminance sensors which detect brightness of the plurality of areas, and performs calibration of the areal illuminance sensors, based on a detected value of the illuminance sensor of the portable terminal device, which is transmitted from the wireless communication section.

2. The system according to claim 1,
wherein the portable terminal device selects an area in which the calibration is performed and transmits information of the selected area to the lighting control device by the wireless communication section.

3. The system according to claim 2,
wherein the portable terminal device includes a display section for displaying the plurality of areas and allowing the area in which the calibration is performed to be selected from the plurality of areas which are displayed.

4. The system according to claim 3,
wherein the portable terminal device displays a layout view of the plurality of areas for selecting the area in which the calibration is performed on the display section by receiving information of the layout view from the lighting control device.

5. The system according to claim 2,
wherein the portable terminal device performs the calibration of the areal illuminance sensors by executing an application program that is downloaded through the wireless communication section.

6. The system according to claim 5,
wherein the portable terminal device transmits notice of the execution of the application program to the lighting control device by the wireless communication section if the application program is executed, and
the lighting control device performs the calibration of the areal illuminance sensor, based on receiving of the notice of the execution.

7. The system according to claim 1,
wherein the lighting control device selects an area in which the calibration is performed and performs the calibration of the areal illuminance sensor of the selected area by using the detected value of the illuminance sensor, which is received with respect to the selected area.

8. The system according to claim 7,
wherein the lighting control device shows the selected area to a person who performs the calibration by performing the dimming control of the plurality of lighting apparatuses so that brightness of the selected area is different from that of areas other than the selected area.

9. The system according to claim 1,
wherein the portable terminal device transmits two different detected values in the selected area, and
the lighting control device performs the calibration of the areal illuminance sensor, based on the two detected values.

10. The system according to claim 1,
wherein the detected value of the illuminance sensor of the portable terminal device is an illuminance value.

11. The system according to claim 1,
wherein the portable terminal device is a smartphone, a potable information terminal or a tablet terminal.

12. A lighting control method using a portable terminal device including an illuminance sensor, a display section and a wireless communication section; and a lighting control device that is capable of communicating with the wireless communication section and performs dimming control of a plurality of lighting apparatuses that respectively illuminate a plurality of areas, based on detected values of a plurality of areal illuminance sensors, which detect brightness of the plurality of areas, comprising:
displaying a layout view of the plurality of areas for selecting an area in which calibration of an areal illuminance sensor is performed on the display section by receiving information of the layout view from the lighting control device;
selecting the area in which the calibration is performed from the plurality of areas which are displayed on the display section; and
transmitting information of the selected area to the lighting control device by the wireless communication section,
wherein the lighting control device performs the calibration of the areal illuminance sensor, based on a detected value of the illuminance sensor of the portable terminal device, which is transmitted from the wireless communication section.

13. The method according to claim 12,
wherein the portable terminal device performs the calibration of the areal illuminance sensor by executing an application program that is downloaded through the wireless communication section.

14. The method according to claim 13,
wherein the portable terminal device transmits notice of the execution of the application program to the lighting control device by the wireless communication section if the application program is executed, and
the lighting control device performs the calibration of the areal illuminance sensor, based on the receiving of the notice of the execution.

15. The method according to claim 12,
wherein the lighting control device selects the area in which the calibration is performed and performs the calibration of the areal illuminance sensor of the selected area by using the detected value of the illuminance sensor, which is received with respect to the selected area.

16. The method according to claim 15,
wherein the lighting control device shows the selected area to a person who performs the calibration by performing the dimming control of the plurality of lighting apparatuses so that brightness of the selected area is different from that of areas other than the selected area.

17. The method according to claim 12,
wherein the portable terminal device transmits two different detected values in the selected area, and
the lighting control device performs the calibration of the areal illuminance sensor, based on the two detected values.

18. The method according to claim 12,
wherein the detected value of the illuminance sensor of the portable terminal device is an illuminance value.

19. The method according to claim 12,
wherein the portable terminal device is a smartphone, a potable information terminal or a tablet terminal.

20. A non-temporary storage medium that stores a program which causes a computer of a portable terminal device including an illuminance sensor, a display section and a wireless communication section, to control a lighting control device that is capable of wireless communication and perform dimming control of a plurality of lighting apparatuses that respectively illuminate a plurality of areas, based on detected values of a plurality of areal illuminance sensors, which detect brightness of the plurality of areas,
wherein the program includes:
displaying a layout view of the plurality of areas from the lighting control device to select an area in which calibration of the areal illuminance sensor is performed on a display section by receiving information of the layout view from the lighting control device,
allowing the area in which the calibration is performed to be selected from the plurality of areas which are displayed on the display section, and
transmitting information of the selected area to the lighting control device by the wireless communication section.
